(19) United States
(12) Patent Application Publication
(10) Pub. No.: US 2013/0060076 A1
(43) Pub. Date: Mar. 7, 2013

(54) METHOD TO REDUCE PCB CONTENT AND/OR LEAD TCLP SOLUBILITY

(71) Applicant: Keith E. Forrester, Meredith, NH (US)

(72) Inventor: Keith E. Forrester, Meredith, NH (US)

(21) Appl. No.: 13/542,031

(22) Filed: Jul. 5, 2012

Related U.S. Application Data
(60) Provisional application No. 61/530,195, filed on Sep. 1, 2011.

(51) Int. Cl. B09C 1/08; A62D 101/08; A62D 101/00

(52) U.S. Cl. 588/400; 588/404; 405/128.7

(57) ABSTRACT

This invention provides a method for the treatment of wastes and materials by addition of Amber Phosphoric Acid to reduce the PCB content and/or TCLP Pb content, thus allowing treated materials or waste to be classified as non-Toxic Substance Control Act (TSCA) waste and/or non-hazardous RCRA solid waste, or otherwise allowed to be reused or land filled at a cost lower than without such treatment.

### RELATED APPLICATION

This application claims the benefit of U.S. Provisional Application No. 61/530,195, filed on Sep. 1, 2011. The entire teachings of the above application are incorporated herein by reference.

### TECHNICAL FIELD

This invention relates to the treatment of contaminated materials, including liquids, suspensions, sludge, sediments, and solids, and in particular to the chemical treatment of waste or contaminated soils and solids containing high concentration levels above 50 ppm of total Polychlorinated Biphenols (PCB) in addition to or separate from lead (Pb) TCLP solubility in solid wastes as regulated under the Resource Conservation and Recovery Act (RCRA), and in particular PCB total content as measurable in materials, wastes, sediments, sludge, and contaminated soils under TSCA, by addition of Amber Phosphoric Acid to reduce the TCLP level and/or total content of the PCB and lead leaching under TCLP extraction test method, thus allowing treated contaminated soils waste to be classified as non-Toxic Substance Control Act (TSCA) waste and/or non-hazardous RCRA solid waste.

### BACKGROUND OF THE INVENTION

The potential dangers of PCB in materials, sludge, sediments, water, soils and solid wastes and lead in water, soils and solid wastes has been a subject of community pressure, public awareness and ever stricter regulatory control in order to reduce or eliminate the dangers to people directly and to the surrounding environments subject to the PCB and lead which present numerous health risks. The leaching of PCB with or without lead into groundwater is a grave concern because of the danger that the drinking water supplies and the environment will become contaminated.

Solid wastes are classified as non-hazardous or hazardous by the United States Environmental Protection Agency (U.S. EPA) pursuant to 40 C.F.R. Part 261, and in addition as TSCA or non-TSCA waste under 40 C.F.R. Part 750 and 761. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity. 40 C.F.R., Part 261.24(a), contains a list of contaminants and their associated maximum allowable concentrations. If a contaminant, such as lead, exceeds its maximum allowable concentration, when tested using the TCLP analysis as specified at 40 C.F.R. Part 261 Appendix 2, then the material is classified as hazardous. Waste containing leachable lead (Pb) is currently classified as hazardous waste due to the toxicity characteristic, if the level of lead extracted in a TCLP analysis is above 5.0 milligrams per liter (mg/L) or parts per million (ppm).

In addition, various states also have promulgated regulations which place special disposal requirements on solid waste which do not leach at concentrations that exceed the TCLP criteria but do leach above certain other criteria. For example, the State of Texas classifies solid wastes which leach lead between 1.5 mg/L and 5.0 mg/L under the TCLP analysis as a non-hazardous, Class 1 solid waste. Special disposal requirements are placed on these wastes which are more costly than if the TCLP results are less than the 1.5 mg/L. Therefore, the goal of solid waste treatment is often to obtain leaching results much lower than the hazardous waste Pb criteria of 5.0 mg/L

In addition to RCRA testing, TSCA defines that waste at total Aroclor PCB levels above 50 ppm compositional are designated a TSCA regulated waste, and thus cannot be disposed at a local Subtitle D solid waste landfill which is often substantially less expensive than the haul and disposal fees for TSCA permitted landfills. There are only a few TSCA permitted landfills operating in the US in addition to several TSCA permitted incinerators, thus often causing extensive expenses for hauling and disposal.

On Aug. 28, 1998 the USEPA revisions to TSCA regulations became effective, and allow PCB bearing wastes such as Auto Shredder Residue (ASR) and wire insulation (CWI) to be disposed at a local landfill and even used as daily cover material given that the TCLP leach test for the solid waste reveals PCB levels to be less than 10 micrograms per liter (ug/l).

The TCLP test is designed to simulate a worst case leaching situation leaching conditions which would typically be found in the interior of an actively degrading municipal landfill. Such landfills normally are slightly acidic with a pH of approximately 5±0.5. Countries such as Switzerland regulate waste on compositional metals, leachable levels and dissolved solids levels also.

The present invention provides a method of reducing the PCB content in materials including solids, liquids, soils, sediments, sludge, water, and wastes and/or the TCLP leaching of lead in solid waste, soils and materials, thus allowing the PCB and/or heavy metal bearing solid waste to be classified as non-TSCA material or waste and/or non-RCRA waste. It is common to find PCB contamination in the presence of heavy metals, thus the invention method provides a means to control PCB content alone or in combination with lead TCLP leaching.

Unlike the present invention, prior art has focused only on reducing the leachability of heavy metals without regard to this new TSCA standard on leachable PCB and/or reduction of PCB content. The present invention reduces the content of the PCB in material or solid waste by use of PCB destruction agent which likely scavenges chlorides from the PCB and substitutes the same to chlorapatite or chloropyromorphite minerals, and also reduces the TCLP Pb by mineralization.

U.S. Pat. No. 5,202,033 describes an in-situ method for decreasing heavy metal leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of leachable metals such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating hazardous waste, including lead, by mixing the solid waste with an agent selected from the group consisting of reactive calcium carbonate, reactive magnesium carbonate and reactive calcium magnesium carbonate.

U.S. Pat. No. 4,652,381 discloses a process for treating industrial waste water contaminated with battery plant waste, such as sulfuric acid and heavy metals by treating the waste with calcium carbonate, calcium sulfate, calcium hydroxide to complete a separation of the heavy metals. However, this is not for use in a landfill situation.

There are also numerous industrial processes in operation throughout the world that are designed for destruction of PCB waste by incineration or solvent extraction and other similar facility based PCB extraction methods for liquid PCB. None of these prior arts on PCB wastes provide an in-field, inexpensive, and mobile means of destruction of PCB and/or TCLP Pb combined stabilization. These inventions and methods in the public domain are all expensive as they often require shipment of the TSCA waste to a processing facility of require extensive on-site PCB extraction or incineration devices. One major advantage of the present invention is its ability to be applied to the waste prior to, during or after production of the waste, thus avoiding TSCA requirements.

Unlike the present invention, however, none of the prior art solutions were designed to nor able to reduce the total content of PCB with or without lead in the waste itself by combination with a simple and inexpensive PCB mass reduction additive such as Amber Phosphoric Acid.

### SUMMARY OF THE INVENTION

The present invention discloses a treatment of materials, liquids, solids, contaminated soils, sediments, sludge, water, wastewater, and solid or liquid waste through the addition of a total PCB mass reduction chemical and/or Pb TCLP leaching reduction additive which is properly chosen to complement the material and waste constituency and therefore, provide the appropriate material and waste characteristics for disposal or reuse after processing The present invention involves the treatment of TSCA regulated waste and materials and/or RCRA hazardous solid waste by the addition of Amber Phosphoric Acid, and a means to reduce contents to improve reuse and disposal.

The present invention provides a method for the total PCB content reduction of TSCA regulated and/or TCLP leaching of lead under RCRA regulated materials or waste, and in particular, waste and contaminated soils containing PCB at total content levels exceeding 50 ppm and TCLP Pb exceeding 5.0 ppm.

### DETAILED DESCRIPTION

The present invention involves the treatment of TSCA regulated or unregulated materials or wastes and/or RCRA hazardous or non-hazardous solid waste to reduce the total content of PCB alone or along with the TCLP leaching of lead, by the addition of Amber Phosphoric Acid, provided by PCS Sales, USA, and sold as Amberphos 54%. The Amber Phosphoric Acid can be used to reduce total PCB content and/or reduce TCLP Pb leaching content.

Table 1 shows the results of PCB total content reduction and TCLP Pb leachable content reduction from a solid waste comprised of contaminated soils, slag, bottom ash and flyash, from a 2011 soil and waste remedial project located in York, Pa., with Amber Phosphoric Acid supplied under patent rights by Forrester Environmental Services, Inc. (FESI). The site soil and waste excavate was batch stabilized in 5 ton mini-batches by trickle-down application of PCS Sales (USA) Inc., supplied Amber Phosphoric Acid (Amberphos 54%) in combination with water spray for dilution and force driving of the trickle-down mini-reactor. For a specific solid waste, the appropriate ratio of PCB reduction and/or lead TCLP leaching reduction additive to solid waste may be arrived at by lab and/or field experimentation. In general the percentage by weight of the PCB content reduction and TCLP Pb leaching reduction additives can range from 0.01% to 1000% on a waste dry weight basis. The dry waste weight addition of additive can vary greatly due to PCB baseline content, baseline TCLP Pb content, and required or desired reuse or non-TSCA and non-RCRA reuse or disposal criteria. The PCB total content reduction and TCLP Pb reduction treatment recipe was 0.25% Amber Phosphoric Acid plus 2% water based on soil and ash mixture as-is wet field weight, added in a mini-batch fixed excavator bucket reactor with application of acid and water by two independent spray bars with several seconds of application and trickle-down followed by gravity free-fall open-air tumbling mixing in sequential mode by each subsequent mini-batch bucket.

TABLE I

| Sample | | |
|---|---|---|
| Slag/Ash and Soil | PCB (mg/kg) | TCLP Pb (mg/l) |
| Baseline | 2.2 | |
| Baseline | 10.3 | |
| Baseline | | 7.4 |
| Baseline | | 17 |
| Treated | ND | ND |
| Treated | ND | ND |

The data in Table I proves that the contaminated soil and waste ash PCB total content and TCLP Pb leachable content were both reduced to non-detectable (<0.05) ppm levels after addition of Amber Phosphoric Acid.

It is understood that the invention disclosed herein is not confined to the particular process disclosed herein; nor to the materials and substances described, but embraces such modified forms thereof as come within the scope of the following claims.

I claim:

1. A method for reducing the Poly Chlorinated Biphenol (PCB) total content in a material and/or waste by addition of Amber Phosphoric Acid.

2. The method of claim 1 wherein the material and/or solid waste contains total PCB content above 50 ppm.

3. The method of claim 1 where Amber Phosphoric Acid is combined with water.

4. The method of claim 1 where the material and/or waste is from the groups including: contaminated materials, liquids, suspensions, sludge, sediments, solids, wastes, contaminated soils, TSCA regulated waste, RCRA regulated soil waste, wastewater, water, groundwater, landfill leachate, ash, dross, slag, municipal solid waste incinerator ash residues, flyash, scrubber residue, coal ash, oil ash, furnace slag, medical waste, municipal solid waste, demolition waste, sand blast residues and spent abrasives, paint wastes, auto shredder wastes, wire insulation wastes, foundry sands, casting wastes, spent pot liners, steel slag and flue flyash waste, mining wastes, PCB contaminated soils, Pb contaminated soils, industrial waste, commercial waste, residential waste, and combinations thereof.

5. A method for reducing both the PCB content and TCLP Pb leaching content of a material or waste by addition of Amber Phosphoric Acid.

6. The method of claim 4 where Amber Phosphoric Acid is combined with water.

7. The method of claim 4 wherein the material and/or solid waste contains total PCB content above 50 mg/kg and TCLP Pb content above 5.0 mg/l.

8. The method of claim 4 where the material and/or waste is from the groups including: contaminated materials, liquids, suspensions, sludge, sediments, solids, wastes, contaminated soils, TSCA regulated waste, RCRA regulated soil waste, wastewater, water, groundwater, landfill leachate, ash, dross, slag, municipal solid waste incinerator ash residues, flyash, scrubber residue, coal ash, oil ash, furnace slag, medical waste, municipal solid waste, demolition waste, sand blast residues and spent abrasives, paint wastes, auto shredder wastes, wire insulation wastes, foundry sands, casting wastes, spent pot liners, steel slag and flue flyash waste, mining wastes, PCB contaminated soils, Pb contaminated soils, industrial waste, commercial waste, residential waste, and combinations thereof.

9. A method for reducing TCLP Pb leaching content of a material or waste by addition of Amber Phosphoric Acid.

10. The method of claim 9 where Amber Phosphoric Acid is combined with water.

11. The method of claim 9 wherein the material and/or solid waste contains TCLP Pb content above 5.0 mg/l.

12. The method of claim 9 where the material and/or waste is from the groups including: contaminated materials, liquids, suspensions, sludge, sediments, solids, wastes, contaminated soils, TSCA regulated waste, RCRA regulated soil waste, wastewater, water, groundwater, landfill leachate, ash, dross, slag, municipal solid waste incinerator ash residues, flyash, scrubber residue, coal ash, oil ash, furnace slag, medical waste, municipal solid waste, demolition waste, sand blast residues and spent abrasives, paint wastes, auto shredder wastes, wire insulation wastes, foundry sands, casting wastes, spent pot liners, steel slag and flue flyash waste, mining wastes, PCB contaminated soils, Pb contaminated soils, industrial waste, commercial waste, residential waste, and combinations thereof.
